(19) United States
(12) Patent Application Publication
(10) Pub. No.: US 2014/0223436 A1
(43) Pub. Date: Aug. 7, 2014

(54) METHOD, APPARATUS, AND SYSTEM FOR PROVIDING AND USING A SCHEDULING DELTA QUEUE

(71) Applicant: AVAYA INC., Basking Ridge, NJ (US)

(72) Inventor: Robert C. Steiner, Broomfield, CO (US)

(73) Assignee: AVAYA INC., Basking Ridge, NJ (US)

(21) Appl. No.: 13/758,704

(22) Filed: Feb. 4, 2013

(51) Int. Cl. G06F 9/46

(52) U.S. Cl. CPC G06F 9/46
USPC 718/102

(57) ABSTRACT

A contact center is described along with various methods and mechanisms for administering the same. Work assignment methods are disclosed that place tasks in bins by time intervals and are processed within a delta queue ring buffer. The delta queue ring buffer can assign the tasks by seconds and order tasks by interval for efficient handling, and then loop around to use the same bins. By using fixed intervals and a moving queue pointer, the scheduling delta queue solution allows for fast selection of the queue to insert and fast processing of the queues on timeout. The scheduling delta queue solution allows for the processing of at least, but not limited to one million tasks with only memory as a constraint.

### FIELD OF THE DISCLOSURE

The present disclosure is generally directed toward communications and more specifically toward contact centers.

### BACKGROUND

Contact centers can provide numerous services to customers, and demand for those services is increasing. A typical contact center includes a switch and/or server to receive and route incoming packet-switched and/or circuit-switched work items and one or more resources, such as human agents and automated resources (e.g., Interactive Voice Response (IVR) units), to service the incoming requests. As products and services become more complex and contact centers evolve to greater efficiencies, new methods and systems are created to keep up with the execution of tasks they need to perform.

Resource allocation systems in contact centers provide resources for performing tasks. The resource allocation system, or work assignment engine, uses task scheduling to manage execution of such tasks. As the number of agents, work items, and tasks increase, more processing capability is needed. As work assignment algorithms become more complex, using methods like deferred matching and calendar-based decisions, the number of timed tasks per work item/agent is averaging higher than in the past. The types of timed tasks may include, but are not limited to, tasks like resource idle, union timer, work timer, deferment time, and many others. A typical work assignment engine has to cancel and reschedule a large number of timed tasks based on objectives and features defined by the contact center.

A common strategy is to use a scheduler which maintains tasks in time order. When a large number of tasks are maintained by the scheduler, it may get bogged down with the cancellation and reinsertion of tasks. The insertion time is linear with the number of tasks scheduled and typically requires walking the task list to near the end of the list. When these tasks are organized and maintained by a scheduler, the insertion/reinsertion becomes expensive.

Delta queues and scheduling arrays are two common types of schedulers. A delta queue-based scheduler is significantly more efficient than an array-based scheduler when measured by processor resource usage. The delta queue-based scheduler requires fewer processor resources to cancel, reinsert, and identify the next task. The delta queue-based scheduler does not require continuous updates to the time values for each particular task. Many contact centers have moved to a delta queue system for more efficient task management.

Even with the increased efficiency of a typical delta queue, the delta queue still represents a processing bottleneck because of the increased processing speed of today's servers. A typical multi-delta queue implementation is not able to keep up with the work assignment engine, using as much as 80% of the central processing unit (CPU) for insertions. A real-time bottleneck may be created when the work is real-time, high-volume, and time-sensitive. There were early efficiency gains using arrays and delta queues, but the need for speed has exceeded the abilities of the current solutions.

### SUMMARY

It is with respect to the above issues and other problems that the embodiments presented herein were contemplated. In particular, embodiments of the present disclosure describe a particular type of time-segmented scheduler, in which a finite number of bins, which are individual delta queues, and a delta queue ring buffer significantly increase the efficiency and speed of task processing.

With a scheduling delta queue, the solution breaks the time into equal segments. In this case, the segments are one second segments and are represented by bins. The tasks that are scheduled for completion are inserted into the appropriate bin based on the second in which they are scheduled, relative to now, like a required queue position (RQP). Instead of the next set of tasks going to a secondary scheduler queue comprising a scheduling array, a second bin is available for insertion for the second time segment, and another bin is available for insertion for the third time segment, and on through the Nth time segment. Each time segment may be on the order of milliseconds, seconds, hours, day, etc. In accordance with embodiments, each of these segments/bins is uniform in its size with respect to the other segments/bins, and each bin is a delta queue. Embodiments of the present disclosure look at the current segment/bin and subsequently process the next segment/bin rather than assessing every segment/bin every time.

In accordance with embodiments of the present disclosure, the delta queue is enhanced through the use of a ring buffer. The ring buffer allows a finite set of bins to be used sequentially and then re-used for maximum efficiency. The delta queue can proceed through a finite number of bins (N) and then through the use of a ring delta queue buffer, the same bins would be used again, starting with N+1, where N is an integer greater than or equal to one.

For example, if an entire processing interval is 8000 seconds (e.g., comprising 8000 delta queues, each delta queue a one-second interval), the scheduling delta queue would process the first second queue, then the second second queue, through the N second queue, and then circle back around and process the 8001 second queue, the 8002 second queue, and so on. By having a fixed time for each interval, the number of queues may be expanded to handle the precise distribution of work scheduling and significantly reduce the scheduling time. This solution also removes the inefficiency created when a high percentage of tasks time out.

In some embodiments, a non-linear variant is provided with binary time intervals (i.e., 0.25 second, 0.5 second, 1 second, 2 second, etc.). Yet another embodiment is to set the interval size and the number of queues dynamically based on the average length of the current delta queue. If the length is large, then the time of an interval could be split in half. If length is small, the number of queues might be reduced by merging intervals.

The term “task” as used herein should be understood to include any program or set of program instructions that are loaded in memory. Execution of tasks by the central processing unit (CPU) or general processing unit (GPU) is based on clock cycles in accord with the program instructions.

The term “bin” as used herein should be understood to mean a real or virtual container of logical information, such as tasks.

The phrase “required queue position (RQP)” as used herein should be understood to mean the place or order in a collection where entities or tasks that are stored and held will be processed later in a particular order based on specific criteria (e.g., First-in-First-out, Last-in-First-out, oldest first, highest priority first, etc.).

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored. When the computer-readable media is configured as a database, it is to be understood that the database may be any type of database, such as relational, hierarchical, object-oriented, and/or the like.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting exemplary pools and bitmaps that are utilized in accordance with embodiments of the present disclosure;

FIG. 3 is an instantiation of a method using a delta queue ring buffer in accordance with embodiments of the present disclosure;

FIG. 4 is a histogram depicting the frequency of task execution in accordance with embodiments of the present disclosure;

FIG. 5 is a first flow diagram depicting a method for the placement of tasks into a delta queue bin in accordance with an embodiment of the present disclosure; and

FIG. 6 is a second flow diagram depicting a bin sequencing method in a ring delta queue buffer in accordance with an embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

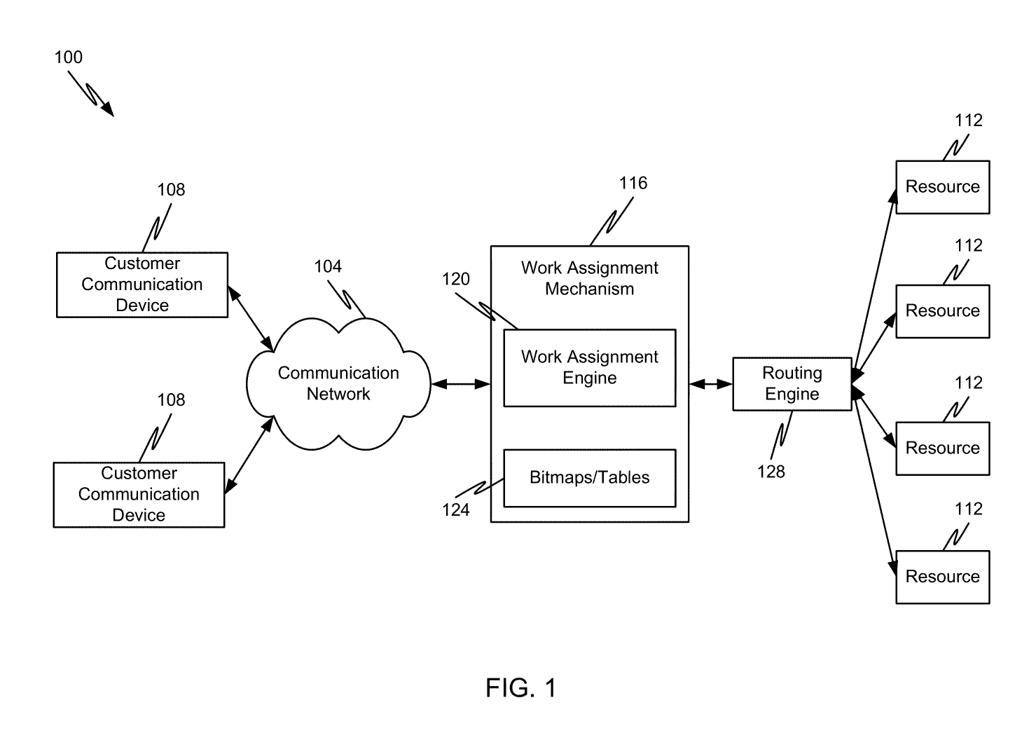

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. Patent Publication No. 2010/0296417 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating tasks based thereon are described in U.S. Patent Publication Nos. 2010/0235218, 2011/0125826, and 2011/0125793, to Erhart et al, filed Mar. 20, 1010, Feb. 17, 2010, and Feb. 17, 2010, respectively, the entire contents of each are hereby incorporated herein by reference in their entirety.

The format of the work item may depend upon the capabilities of the communication device 108 and the format of the communication.

In some embodiments, work items and tasks are logical representations within a contact center of work to be performed in connection with servicing a communication received at the contact center (and more specifically the work assignment mechanism 116). With respect to the traditional type of work item, the communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 which initiated the communication with the assigned resource 112.

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. Patent Application Serial No. 2011/0255683 filed Sep. 15, 2010, the entire contents of which are hereby incorporated herein by reference.

More specifically, the work assignment engine 120 can generate bitmaps/tables 124 and determine, based on an analysis of the bitmaps/tables 124, which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching by utilizing the bitmaps/tables 124 and any other similar type of data structure.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

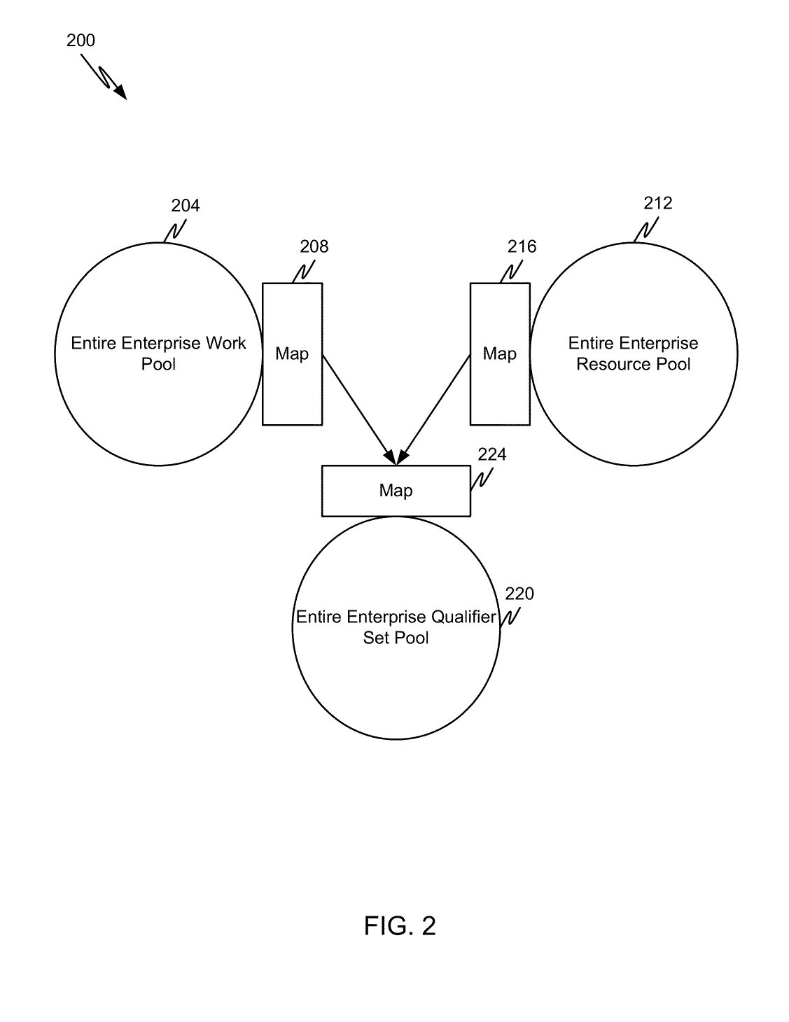

FIG. 2 depicts exemplary data structures 200 which may be incorporated in or used to generate the bitmaps/tables 124 used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center at any given time.

In some embodiments, the population of the work pool 204 may be limited to work items waiting for service by or assignment to a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item 228, 232 in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Accordingly, the values in the bitmaps 208, 216, 224 may be recalculated each time the state of a pool changes (e.g., when a work item surplus is detected, when a resource surplus is detected, etc.).

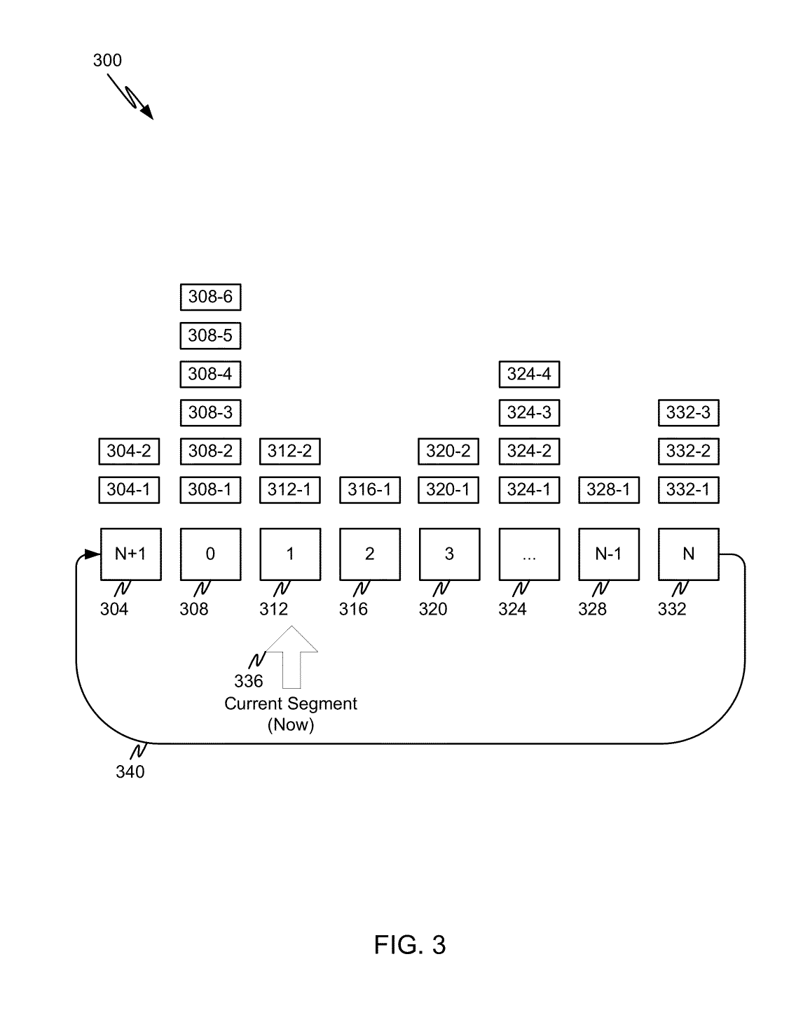

FIG. 3 is a diagram depicting an instantiation of a scheduling delta queue 300 with a ring buffer which may be used by a work assignment mechanism 116 or a resource 112 to efficiently process tasks.

In some embodiments, a delta queue is configured to schedule contact center tasks, as described at least in part in U.S. Pat. No. 7,500,241, issued Mar. 3, 2009, to Flockhart et al, and U.S. Pat. No. 8,094,804, issued Jan. 10, 2012, to Flockhart et al, the entire contents of each are hereby incorporated herein by reference in their entirety.

A work assignment mechanism 116 may have certain tasks pending execution. These tasks typically need to be executed based on certain parameters, such as time and in a certain order. To facilitate the most efficient execution of tasks, a special type of scheduling delta queue 300 may be used.

The scheduling delta queue 300 may break time into equal segments or bins. In a preferred embodiment, the segments may be one second segments which are uniform and each segment may be a delta queue. The scheduling delta queue 300 may comprise a set of segments/bins 304, 308, 312, 316, 320, 324, 328, 332 where the set may be more or fewer than depicted, and where each bin represents a one second segment. The bins 304, 308, 312, 316, 320, 324, 328, 332 may contain one or more work items or tasks. For example, bin 308 may contain work items or tasks 308-1, 308-2, 308-3, 308-4, 308-5, 308-6 and bin 316 may contain one task 316-1. Each segment/bin may have more or fewer tasks than depicted.

A task 324-1 that is scheduled for completion may be inserted, for example, in bin 324 based on the time period in which it is scheduled to be executed. The time period in which a task 324-1 is scheduled to be executed may correspond to an absolute time or a time period relative to current time 336. Rather than sending subsequent tasks to a secondary scheduler queue comprising a scheduling array, a second insertion point may be available for a task 324-2 within bin 324, a third insertion point may be available for a task 324-3 within bin 324, and a fourth insertion point may be available for a task 324-4 within bin 324, and so on.

In some embodiments, the scheduling delta queue may only consider the current bin/segment 312 and process tasks within that bin/segment 312. For instance, the work assignment engine 120 may begin by executing task 312-1. The work assignment engine then processes the next task 312-2, rather than having to assess bin 316, 320, 324 and so on before executing task 312-2. Significant efficiencies may be achieved by removing the requirement to check every subsequent segment every time. Instead, all tasks may be executed within a bin and then the process increments to the next bin. In other words, the time-consuming process of incrementing can be delayed until all tasks within a bin have been executed.

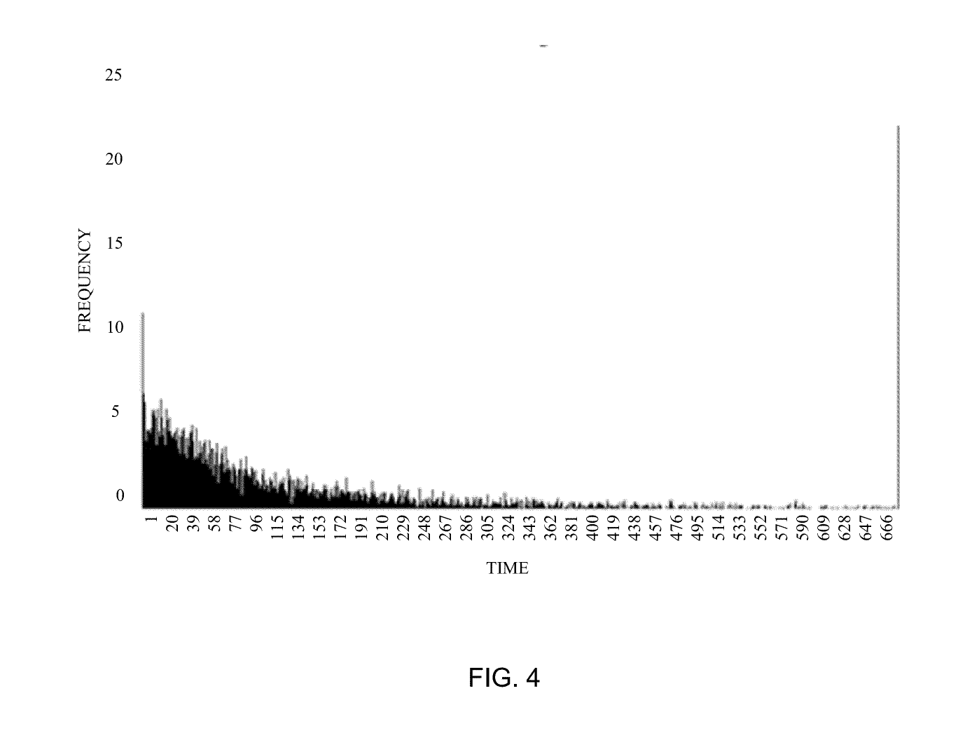

FIG. 4 is a histogram depicting the frequency of task execution in accordance with embodiments of the present disclosure. The vertical axis may represent the number of tasks, and the horizontal axis may represent the time relative to now. In this example, the execution of tasks is graphed showing a large number of seconds to show the relative change in efficiency as time elapses, and thus the bin number, gets larger. The scheduling delta queue 300 increases efficiency at early intervals, but may be less effective as time increases and frequency decreases. Most of the tasks will be completed in an early interval, and by the late bins the tasks may have already been completed, expired, or rescheduled. By adding a delta queue ring buffer 340, the use of one-second bins in a delta queue to minimize processor resources may be further enhanced to automatically wrap around to the beginning, to the first bin of the delta queue. This may allow the ring buffer to be used without the limitation or requirement of a fixed queue size and may allow maximum efficiency based on the frequency of tasks in early bins.

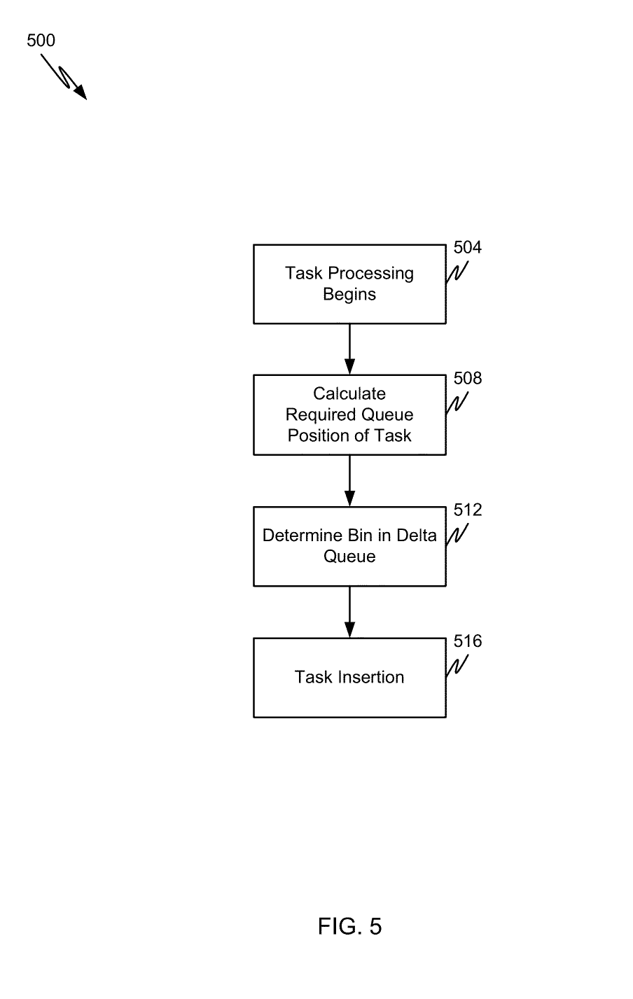

FIG. 5 is a first flow diagram depicting the placement of tasks into a delta queue bin in accordance with an embodiment of the present disclosure. While a general order for the steps of the method 500 are shown in FIG. 5, the method 500 can include more or fewer steps or the order of the steps can be arranged differently than those shown in FIG. 5. The method 500 can be executed as a set of computer-executable instructions executed by a computer system and encoded or stored on a non-transitory computer readable medium.

Generally, the method begins with a work item or task that comes into the work assignment engine 120 within the work assignment mechanism 116. The task processing begins, in step 504. The work assignment engine 120 may determine when the task should be executed. In step 508, based on the information delivered with the task, the work assignment engine 120 can calculate the required queue position for the task. In some embodiments, the bins in a scheduling delta queue are set in intervals of one second each. The work assignment engine 120 can determine in which bin the task should be placed, in step 512. Once the work assignment engine 120 has determined in which bin to place the task, the work assignment 120 engine may insert the task into the required queue position in that bin, in step 516.

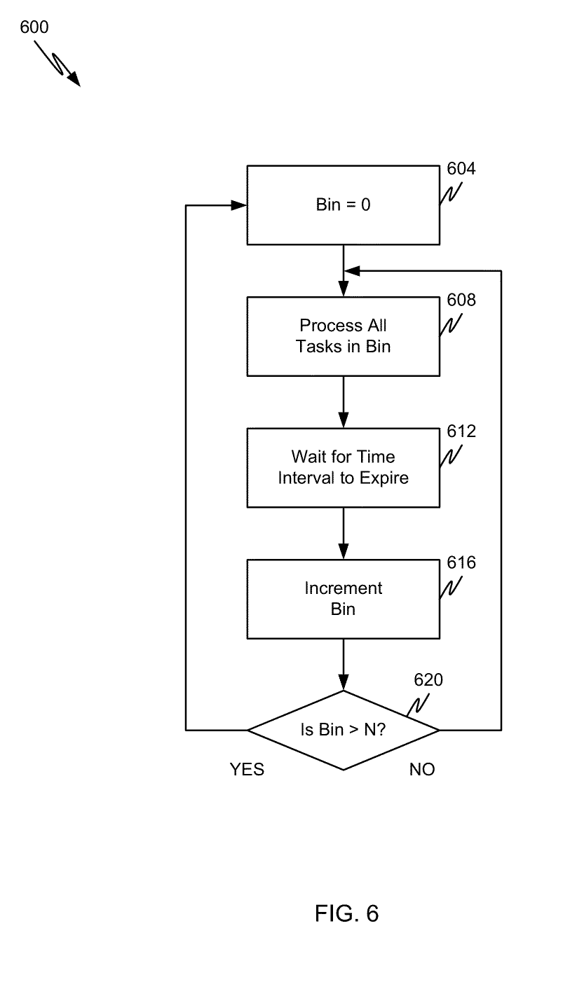

FIG. 6 is a second flow diagram depicting a bin sequencing method in a ring delta queue buffer in accordance with an embodiment of the present disclosure. While a general order for the steps of the method 600 are shown in FIG. 6, the method 600 can include more or fewer steps or the order of the steps can be arranged differently than those shown in FIG. 6. The method 600 can be executed as a set of computer-executable instructions executed by a computer system and encoded or stored on a non-transitory computer readable medium.

Generally, the method begins with a work item or task that comes into the work assignment engine 120 within the work assignment mechanism 116. As discussed in conjunction with FIG. 5, tasks may be placed into one or more bins based on the time or segment information provided by the tasks. In step 604, task processing begins with bin 0.

The work assignment engine 120 is operable to process all of the tasks in bin 0, in step 608, in time order. If there is time left after the tasks have been executed, the work assignment engine 120 may optionally wait for the remainder of the one second interval to expire, in step 612. In step 616, the count may increment to bin 1 which is the next bin in the scheduling delta queue. The work assignment engine 120 then determines if the bin number is greater than N, in step 620.

If the bin number is not greater than N, the work assignment engine 120 may begin processing all the tasks in bin 1, in step 608. If there is time left after the tasks have been executed, the work assignment engine 120 may wait for the remainder of the one second interval to expire, in step 612. In step 616, the count may increment to bin 2 which is the next bin in the scheduling delta queue. The work assignment engine 120 asks if the bin number is greater than N, in step 620.

If the bin number is not greater than N, the work assignment engine 120 may begin processing all the tasks in bin 2, in step 608. If there is time left after the tasks have been executed, the work assignment engine 120 may wait for the remainder of the one second interval to expire, in step 612. In step 616, the count may increment to bin 3 which is the next bin in the scheduling delta queue. The work assignment engine 120 asks if the bin number is greater than N, in step 620.

If the bin number is not greater than N, the work assignment engine 120 may begin processing all the tasks in bin 3, in step 608. If there is time left after the tasks have been executed, the work assignment engine 120 may wait for the remainder of the one second interval to expire, in step 612. In step 616, the count may increment to bin 4 which is the next bin in the scheduling delta queue. The work assignment engine 120 asks if the bin number is greater than N, in step 620.

If the bin number is not greater than N, the work assignment engine 120 may begin processing all the tasks in bin 4, in step 608. If there is time left after the tasks have been executed, the work assignment engine 120 may wait for the remainder of the one second interval to expire, in step 612. In step 616, the count may increment to bin 5 which is the next bin in the scheduling delta queue. The work assignment engine 120 asks if the bin number is greater than N, in step 620.

If the bin number is not greater than N, the work assignment engine 120 may begin processing all the tasks in bin 5, in step 608. If there is time left after the tasks have been executed, the work assignment engine 120 may wait for the remainder of the one second interval to expire, in step 612. In step 616, the count may increment to bin 6 which is the next bin in the scheduling delta queue. The work assignment engine 120 asks if the bin number is greater than N, in step 620.

If the bin number is not greater than N, the work assignment engine 120 may begin processing all the tasks in bin 6, in step 608. If there is time left after the tasks have been executed, the work assignment engine 120 may wait for the remainder of the one second interval to expire, in step 612. In step 616, the count may increment to bin 7 which is the next bin in the scheduling delta queue. The work assignment engine 120 asks if the bin number is greater than N, in step 620.

If the bin number is not greater than N, the work assignment engine 120 may begin processing all the tasks in bin 7, in step 608. If there is time left after the tasks have been executed, the work assignment engine 120 may wait for the remainder of the one second interval to expire, in step 612. In step 616, the count may increment to bin 8 which is the next bin in the scheduling delta queue. The work assignment engine 120 asks if the bin number is greater than N, in step 620.

If the bin number is not greater than N, the work assignment engine 120 may begin processing all the tasks in bin 8, in step 608. If there is time left after the tasks have been executed, the work assignment engine 120 may wait for the remainder of the one second interval to expire, in step 612. In step 616, the count may increment to bin 9 which is the next bin in the scheduling delta queue. The work assignment engine 120 asks if the bin number is greater than N, in step 620.

If the bin number is not greater than N, the work assignment engine 120 may begin processing all the tasks in bin 9, in step 608. If there is time left after the tasks have been executed, the work assignment engine 120 may wait for the remainder of the one second interval to expire, in step 612. In step 616, the count may increment to bin 10 (where N=10) which is the next bin in the scheduling delta queue. The work assignment engine 120 asks if the bin number is greater than N, in step 620.

If the bin number is not greater than N, the work assignment engine 120 may begin processing all the tasks in bin 10, in step 608. If there is time left after the tasks have been executed, the work assignment engine 120 may wait for the remainder of the one second interval to expire, in step 612. In step 616, the count may increment to bin 11=N+1 (where Bin>N) which is the next bin in the scheduling delta queue. The work assignment engine 120 asks if the bin number is greater than N, in step 620.

When the answer is yes, the work assignment engine 120 loops back around to bin 0 and the process begins again, in step 604. The combination of task insertion and bin sequencing provide efficient use of the scheduling delta queue within and through the segments.

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
organizing tasks for execution by a processor into a scheduling delta queue, the scheduling delta queue comprising a plurality of bins, each bin incrementally representing a different predetermined period of time during which different subsets of the tasks for execution are to be executed by the processor;
during a first predetermined period of time, executing, with the processor, each task within a first bin in the plurality of bins;
determining that each task within the first bin has been executed prior to expiration of the first predetermined period of time;
thereafter, waiting until expiration of the first predetermined period of time without processing any further tasks;
following expiration of the first predetermined period of time, incrementing to a second bin in the plurality of bins; and
during a second predetermined period of time, executing each task within the second bin.

2. The method of claim 1, further comprising:
determining that each task within the second bin has been executed prior to expiration of the second predetermined period of time;
thereafter, waiting until expiration of the second predetermined period of time without processing any further tasks; and
following expiration of the first predetermined period of time, incrementing to a third bin in the plurality of bins.

3. The method of claim 1, wherein the plurality of bins comprises N bins, where N is an integer greater than or equal to two, the method further comprising:
determining that processing tasks in each of the N bins have been processed; and
thereafter, returning back to the first bin to begin processing a new set of tasks that have been assigned to the first bin.

4. The method of claim 1, wherein a task that has timed out is removed from a bin prior to execution of the task.

5. The method of claim 1, wherein at least some of the tasks correspond to contact center tasks.

6. The method of claim 1, wherein tasks are assigned to a bin in the plurality of bins based at least on a required queue position (RQP).

7. The method of claim 1, wherein the first predetermined period of time corresponds to a second.

8. The method of claim 1, wherein each bin is uniform in size with respect to every other bin the in plurality of bins.

9. The method of claim 1, wherein the first predetermined period of time is different in size as compared to the second predetermined period of time.

10. The method of claim 9, wherein the first predetermined period of time is larger than the second predetermined period of time.

11. A non-transitory computer-readable medium comprising processor-executable instructions, the instructions comprising:
instructions configured to organize tasks for execution into a scheduling delta queue, the scheduling delta queue comprising a plurality of bins, each bin incrementally representing a different predetermined period of time during which different subsets of the tasks for execution are to be executed;
instructions configured to, during a first predetermined period of time, execute each task within a first bin in the plurality of bins;
instructions configured to determine that each task within the first bin has been executed prior to expiration of the first predetermined period of time;
instructions configured to wait until expiration of the first predetermined period of time without processing any further tasks;
instructions configured to, following expiration of the first predetermined period of time, increment to a second bin in the plurality of bins; and
instructions configured to, during a second predetermined period of time, execute each task within the second bin.

12. The computer-readable medium of claim 11, wherein the instructions further comprise:
instructions configured to determine that each task within the second bin has been executed prior to expiration of the second predetermined period of time;
instructions configured to wait until expiration of the second predetermined period of time without processing any further tasks; and
instructions configured to, following expiration of the first predetermined period of time, increment to a third bin in the plurality of bins

13. The computer-readable medium of claim 11, wherein the plurality of bins comprises N bins, where N is an integer greater than or equal to two, the instructions further comprising:
instructions configured to determine that processing tasks in each of the N bins have been processed; and
instructions configured to return back to the first bin to begin processing a new set of tasks that have been assigned to the first bin.

14. The computer-readable medium of claim 11, wherein a task that has timed out is removed from a bin prior to execution of the task.

15. The computer-readable medium of claim 11, wherein at least some of the tasks correspond to contact center tasks.

16. The computer-readable medium of claim 11, wherein tasks are assigned to a bin in the plurality of bins based at least on a required queue position (RQP).

17. The computer-readable medium of claim 11, wherein the first predetermined period of time corresponds to a second.

18. The computer-readable medium of claim 11, wherein each bin is uniform in size with respect to every other bin the in plurality of bins.

19. The computer-readable medium of claim 11, wherein the first predetermined period of time is different in size as compared to the second predetermined period of time.

20. The computer-readable medium of claim 19, wherein the first predetermined period of time is larger than the second predetermined period of time.
